(19) United States
(12) Patent Application Publication
(10) Pub. No.: US 2019/0271799 A1
(43) Pub. Date: Sep. 5, 2019

(54) OPTICAL COMPONENTS HAVING HYBRID NANO-TEXTURED ANTI-REFLECTIVE COATINGS AND METHODS OF MANUFACTURE

(71) Applicant: Newport Corporation, Irvine, CA (US)

(72) Inventors: Thomas Sosnowski, San Jose, CA (US); Alan Petersen, Palo Alto, CA (US); Richard Boggy, Sunnyvale, CA (US); Christoph Thijssen, Mountain View, CA (US); Steven Utter, Livermore, CA (US); Mark Feldman, Castro Valley, CA (US)

(73) Assignee: Newport Corporation, Irvine, CA (US)

(21) Appl. No.: 16/289,203

(22) Filed: Feb. 28, 2019

Related U.S. Application Data
(60) Provisional application No. 62/637,380, filed on Mar. 1, 2018.
(60) Provisional application No. 62/637,368, filed on Mar. 1, 2018.

(51) Int. Cl. G02B 1/11; G02B 1/12

(52) U.S. Cl. CPC G02B 1/11; G02B 1/12

(57) ABSTRACT

The present application is directed to various embodiments of optical components having hybrid nano-textured anti-reflective coatings applied thereto which includes at least one substrate having at least one substrate body defining at least one surface, at least one layer may be applied to a surface of the substrate body, and at least one nano-textured surface formed on least one layer applied to the surface of the substrate body.

### CROSS-REFERENCE TO RELATED APPLICATIONS

The present application claims priority to U.S. Provisional Pat. Appl. No. 62/637,368, entitled “Hybrid Nano-Textured Anti-Reflective Coatings and Devices,” filed on Mar. 1, 2018, and U.S. Provisional Pat. Appl. No. 62/637,380, entitled “Nano-Textured Dielectric Coatings for Dispersion Control,” filed on Mar. 1, 2018, the contents of which are both incorporated by reference in their entirety herein.

### BACKGROUND

Anti-reflective coatings are commonly used on a wide variety of optical substrates. Typically, multiple layers of dielectric materials are applied to a substrate. Often, the index of refraction of the dielectric layers of material applied to the substrate alternates between high index of refraction and low index of refraction. While anti-reflective coatings have performed adequately in most applications a number of shortcomings have been identified. For example, in some applications, the desired coating characteristics (reflection, bandwidth, transmitted phase, absorption, damage threshold, and the like) may be difficult to achieve simultaneously using conventional vacuum-deposited multilayer dielectric coatings.

In response, nano-textured surfaces on some substrates have been developed which, in some circumstances, offer advantages over conventional dielectric coatings applied using conventional coating methods. Production of such nano-textured surfaces often involves plasma-assisted etching. The details and effectiveness of such a process can be dependent on the material and its amorphous or crystalline state. At present, nano-textured surfaces have been produced mostly on relatively hard, isotropic and well understood materials such as glass and YAG crystals. Unfortunately, some applications require the use of nonlinear, electro-optic, acousto-optic or other special materials having single crystalline structures and highly anisotropic surface characteristics. Typically, these materials will exhibit different properties including etch rate, dependent on crystalline orientation. Thus, the nano-texturing process may not be applicable to all crystalline orientations required by different applications. In addition, many nonlinear and other specialized optical crystals are mechanically or environmentally sensitive. In particular, the hygroscopic or adsorptive nature of a surface may be exacerbated by the increased effective area of the nano-textured surface. As such, nano-texturing of optical surfaces may be problematic on many materials and substrates where it would otherwise be useful.

Thus, in light of the foregoing, there is an ongoing need for hybrid nano-textured antireflective coatings and devices.

### SUMMARY

The present application is directed to various embodiments of optical components having hybrid nano-textured anti-reflective coatings applied thereto. In one embodiment, the present application discloses an optical component having a hybrid nano-textured anti-reflective coating and includes at least one substrate having at least one substrate body defining at least one surface. At least one layer may be applied to a surface of the substrate body. Further, at least one nano-textured surface may be formed on least one layer applied to the surface of the substrate body.

In another embodiment, the present application discloses an optical component having a hybrid nano-textured anti-reflective coating having at least one substrate including at least one substrate body defining at least one surface. At least one layer may be applied to the surface of the substrate body. In addition, at least one nano-textured surface may be formed in the layer applied to the surface of the substrate body. Further, at least one processing layer may be applied to the at least one of the substrate body and the nano-textured surface.

The present invention further discloses a method of manufacturing an optical component having a broadband anti-reflective coating having a high damage threshold applied thereto. More specifically, at least one substrate having a substrate body is provided. At least one layer may be applied to a surface of the substrate body. Thereafter, at least one nano-textured surface may be formed on the layer applied to the surface of the substrate body.

Other features and advantages of the optical components having hybrid nano-textured anti-reflective coatings as described herein will become more apparent from a consideration of the following detailed description.

### BRIEF DESCRIPTION OF THE DRAWINGS

The novel aspects of optical components having hybrid nano-textured anti-reflective coatings as disclosed herein will be more apparent by review of the following figures, wherein:

FIG. 1 shows a cross-sectional view of an embodiment of an optical component having a hybrid nano-textured anti-reflective coating applied to the substrate body;

FIG. 2 shows an elevated perspective view of the embodiment of an optical component having a hybrid nano-textured anti-reflective coating applied to the substrate body shown in FIG. 1;

FIG. 3 shows a cross-sectional view of another embodiment of optical component having a hybrid nano-textured anti-reflective coating applied to the substrate body;

FIG. 4 shows a cross-sectional view of another embodiment of optical component having a hybrid nano-textured anti-reflective coating applied to the substrate body; and

FIG. 5 shows a cross-sectional view of another embodiment of optical component having a hybrid nano-textured anti-reflective coating applied to the substrate body.

### DETAILED DESCRIPTION

The present application is directed to various embodiments of optical surfaces having one or more nano-textured anti-reflective coatings applied thereto. In some embodiments, the nano-textured anti-reflective coating comprises a single layer coating. In other embodiments, the nano-textured anti-reflective coating comprises a multilayer coating wherein at least one layer of the multilayer stack includes nano-texturing features or elements thereon. During use, the nano-textured anti-reflective coatings applied to the optical substrate represents a graded optical index of refraction and may be configured to provide anti-reflection characteristics over a wider range of wavelength and angle of incidence as compared to conventional coating techniques. Furthermore, the nano-textured anti-reflective coatings may be configured to exhibit a higher optical damage threshold than conventional techniques. While the coatings described herein are directed to anti-reflective coatings those skilled in the art will appreciate that any variety of coatings may include one or more nano-textured features or elements formed thereon.

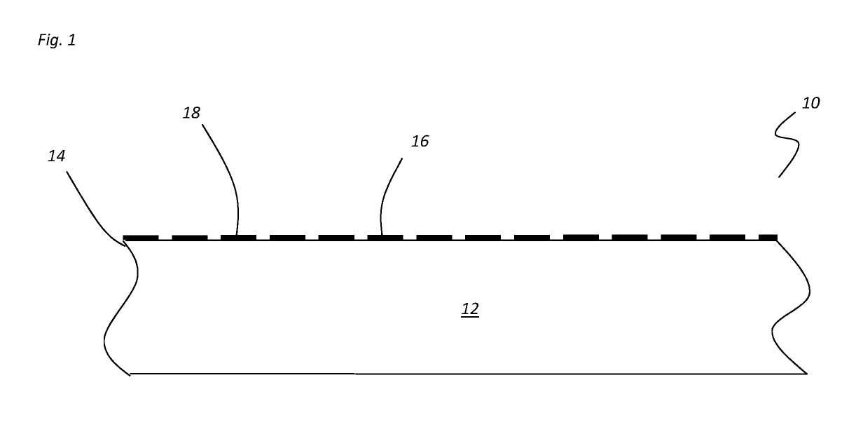

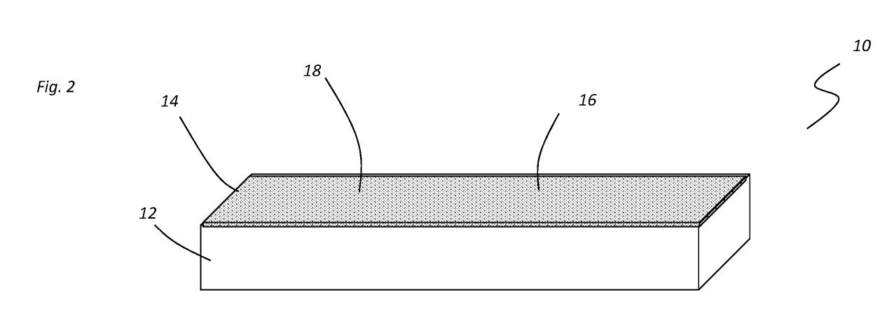

FIGS. 1 and 2 show various views of an embodiment of a hybrid nano-textured anti-reflective coated substrate 10. As shown, the hybrid nano-textured anti-reflective coated substrate 10 includes at least one substrate body 12 having at least one surface 14 configured to have one or more coatings or layers 16 selectively applied thereto. In one embodiment, the layer 16 comprises at least one anti-reflective coating, although those skilled in the art will appreciate that any variety of coatings may be applied to any surface of the substrate body 12. In one embodiment, the substrate body 12 is manufactured from at least one nonlinear optical material. Exemplary anisotropic nonlinear optical materials include, without limitation, β-Barium borate (BBO), Lithium triborate (LBO), Cesium lithium borate (CLBO), Bismuth triborate (BIBO), Potassium titanyl phosphate (KTP), and Potassium dihydrogen phosphate (KDP), rubidium titanyl phosphate (RTP), potassium beryllium fluoroborate (KBBF), rubidium beryllium fluoroborate (RBBF), lithium niobate, periodically-poled lithium niobate (PPLN) and strontium beryllium borate (SBBO). Optionally, the substrate body 12 may be manufactured from at least one anisotropic linear optical material. Further, the substrate body 12 may be manufactured from Yttrium aluminum garnet (YAG). In another embodiment, the substrate body 12 may be manufactured from lutetium aluminum garnet (LuAG), calcium fluoride (CaF₂), or similar relatively isotropic, crystalline materials. Optionally, the substrate body 12 may be manufactured from any variety of materials having a single crystalline structure or similar densified materials. In another embodiment, the substrate body 12 may be manufactured from glass, silica, ceramic materials, polymers, and the like. Those skilled in the art will appreciate that the substrate body 12 may be manufactured in any variety of transverse dimensions and surface features.

Referring again to FIGS. 1 and 2, the layer 16 may be applied to the surface 14 of the substrate body 12 using any variety of methods or techniques. In one embodiment, the material and deposition technique of the layer 16 may be chosen such that it can be readily nano-textured, independent of the character of the substrate body 12. In one embodiment, the index of refraction of the layer 16 is closely matched to the index of refraction of the substrate body 12. For example, in one embodiment, the layer 16 comprises a densified layer of SiO₂ applied to a substrate body 12 manufactured from LBO using an ion beam sputtering process. Alternate materials which may be used to form the layer 16 include, without limitations, diamond-like carbon, HfO₂, Al₂O₃, Ta₂O₃ or similar materials. As such, the layer 16 may be manufactured from amorphous materials, non-amorphous materials, isotropic materials, anisotropic materials, and the like. In one embodiment, the layer 16 has a physical thickness on the order of an optical wavelength. As such, the layer 16 may have a minimal effect on the optical properties of the substrate body 12. Those skilled in the art will appreciate that the amorphous layer 16 may be applied to the substrate body 12 using any variety of methods, including, without limitations, vacuum deposition, ion beam sputtering, sol-gel processing methods and the like.

As shown in FIGS. 1 and 2, the layer 16 applied to the surface 14 of the substrate body 12 may undergo nano-texturing processing which results in at least one nano-textured surface 18 formed in the anti-reflective layer 16 applied to the substrate body 12 thereby providing a nano-textured anti-reflective coated substrate 10 having a broadband anti-reflective coating having a high damage threshold and configured to minimize ripples associated with group delay dispersion. In general, the amorphous layer 16 (such as SiO₂) is very robust and well characterized, thereby allowing for well-understood vacuum deposition and plasma etching processes. In one embodiment, the nano-textured surface 18 may be formed by nano-texturing processes configured to provide a random nano-textured surface. In another embodiment, the nano-textured surface 18 may be formed by nano-texturing processes configured to provide a specific or non-random nano-textured surface. Further, the nano-textured surface 18 may be uniformly formed in the layer 16 applied to the surface 14 of the substrate body 12. In another embodiment, the nano-textured surface 18 may be non-uniformly formed in the layer 16 applied to the surface 14 of the substrate body 12, thereby forming area of the nano-textured surface 18 and areas of non-textured layer 16.

As stated above, the nano-textured surface 18 formed in the layer 16 of the anti-reflective coated substrate 10 may be formed using any variety of nano-texturing processes and methods. For example, U.S. Pat. No. 8,187,481 (hereinafter '481 patent), which is incorporated in its entirety herein, describes one etching method useful for forming anti-reflective nano-structures within the body of an optical substrate. In contrast, the nano-textured surface 18 formed in the layer 16 of the anti-reflective coated substrate 10 may be formed using various laser ablation processes known in the art. Optionally, the nano-textured surface 18 formed in the layer 16 of the anti-reflective coated substrate 10 may be formed during the process of forming/applying the layer 16 to the substrate body 12 using various methods known in the art of optical coating.

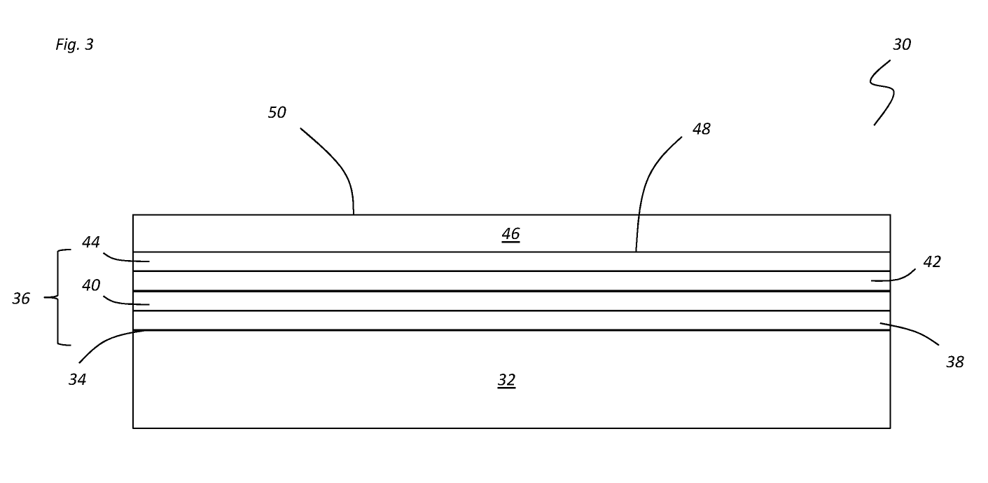

FIGS. 3-5 show various views of alternate optical components having a nano-textured anti-reflective coating applied thereto. In one specific embodiment, the nano-textured anti-reflective coating may be applied to mirrors, chirped mirrors and similar optical components configured for use within a laser system configured to output ultrashort optical pulses, although those skilled in the art will appreciate that the nano-textured anti-reflective coatings disclosed herein may be applied to any variety of optical components. In one embodiment, a chirped mirror may refer to a device wherein the optical dispersion properties of a dielectric material forming reflective structure are dependent on control of reflection at the dielectric to air interface. In one embodiment, the chirped mirror may use the randomized anti-reflection approach resulting in greater control of the dispersive characteristics of the mirror. As such, in one embodiment, a chirped mirror could comprise any dielectric coated mirror for which dispersion characteristics are included in the design development of the mirror coating. Since it is a practical difficulty to create an effective anti-reflection coating at the air-to-dielectric interface for broadband use (over a wide spectral range), the use of the broadband characteristics of the randomized anti-reflection process can benefit in such dispersion control. FIG. 3 shows an embodiment of a chirped mirror having a nano-textured anti-reflective coating applied thereto. As shown, the chirped mirror 30 includes a substrate body 32 defining at least one surface 34. As shown, a multi-layer dielectric stack 36 may be applied to the surface 34 of the substrate body 32. Like the previous embodiment, the substrate body 32 may be manufactured from any variety of materials, including, without limitations, a single crystalline structure or similar densified materials. In another embodiment, substrate body 32 may be glass, silica, ceramic materials, polymers, and the like. In another embodiment, the substrate body 32 may be manufactured from yttrium aluminum garnet (YAG), lutetium aluminum garnet (LuAG), calcium fluoride (CaF₂), or similar relatively isotropic, crystalline materials. Optionally, β-Barium borate (BBO), lithium triborate (LBO), cesium lithium borate (CLBO), bismuth borate (BIBO), potassium titanyl phosphate (KTP), and potassium dihydrogen phosphate (KDP) may be used to form the substrate body 32.

In one embodiment, the multilayer dielectric stack 36 comprises alternating layers of materials having a high index of refraction and materials having a low index of refraction. For example, in the illustrated embodiment dielectric layers 38, 42 are formed from materials having a high index of refraction. In contrast, layers 40, 44 are comprised of materials having a low index of refraction. Exemplary materials used to form the layers of material having a high index of refraction include, without limitation, TiOₓ, TiO₂, Nb₂O₃, Ta₂O₅, HfO₂, Sc₂O₃, Y₂O₃, Al₂O₃, Gd₂O₃. Similarly, exemplary materials used to form the layers of material having a low index of refraction include, without limitation, SiO₂, MgF₂, Al₂O₃, and AlF₃. Optionally, the multilayer stack 36 may be manufactured with one or more layers of non-dielectric materials. In the illustrated embodiment, the multilayer dielectric stack 36 includes four layers of materials, although those skilled in the art will appreciate that the multilayer dielectric stack 36 may include any number of layers of dielectric material. In one embodiment, the layers 38, 40, 42, 44 forming the multilayer dielectric stack 36 may be applied to any surface 44 of the substrate body 32 using any variety of deposition processes. For example, in one embodiment the various layers 38, 40, 42, 24 are applied using e-beam deposition processes. In another embodiment, the various layers 38, 40, 42, 44 are applied using ion beam sputtering. As such, the various layers 38, 40, 42, 44 may have any desired thickness. Optionally, at least one of the various layers 18, 40, 42, 24 may include one or more features formed thereon, For example, at least one of the various layers 38, 40, 42, 44 may be nano-textured or otherwise conditioned to improve mirror performance. As such, in one alternate embodiment, the chirped mirror 30 may include nano-textured dielectric stack 36 applied to at least one surface 34 of the substrate body 32, thereby eliminating the need for additional processing or the inclusion of processing layers.

Referring again to FIG. 3, at least one processing layer 46 may be applied to the substrate body 32 proximate to at least one layer of the multilayer dielectric stack 36. In the illustrated embodiment, the processing layer 46 is applied to the dielectric layer 44 having a low index of refraction. Like the various layers 38, 40, 42, 24, the processing layer 46 may have any desired thickness and may be applied to the substrate body 32 using any variety of coating processes and techniques. In one embodiment, the processing layer 46 comprises SiO₂, although those skilled in the art will appreciate that any variety of materials may be used to form the processing layer 46. Other materials include, without limitations, amorphous carbon (a-C, a-C;H), SiC, polymeric-like carbon (PLC), hydrogenated diamond-like carbon, HfO₂, or similar materials. In one embodiment, the processing layer 46 is formed from amorphous materials, although those skilled in the art will appreciate that the processing layer 46 need not be manufactured from amorphous materials. As such, any variety of materials may be used to form the processing layer 46. Thereafter, the processing layer 46 may undergo one or more nano-texturing processes. For example, in one embodiment the processing layer 46 applied to the multi-dielectric stack 36 undergoes at least one plasma etch process thereby creating a nano-textured processing layer. As shown in FIG. 3, in one embodiment the nano-texturing process is applied to surface 50 of the processing layer 46. In an alternate embodiment, the nano-texturing process is applied to surface 48 of the processing layer 46. Optionally, the nano-texturing process may be applied to both surfaces 48, 50 of the processing layer 46. Those skilled in the art will appreciate that the nano-texturing pattern formed on at least one of the surfaces 48, 50 of the processing layer 46 may comprise a random pattern, a nonrandom pattern, a uniform pattern, and or a non-uniform pattern. For example in one embodiment the entire surface 50 of the processing layer 46 includes a random nano-textured processing pattern formed thereon. In an alternate embodiment, partial sections of the surface 50 of the processing layer 46 include a nano-textured processing pattern thereon. As a result, the nano-textured processing layer 46 and multilayer dielectric stack 36 of the chirped mirror 30 produces a chirped mirror 30 having a broadband anti-reflective coating having a high damage threshold and configured to minimize ripples associated with group delay dispersion.

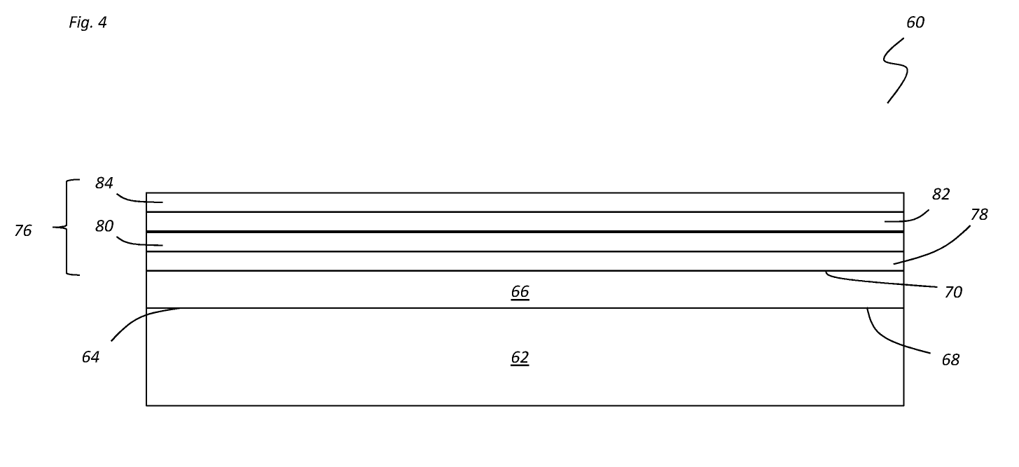

FIG. 4 shows an alternate embodiment of a chirped mirror having a nano-textured anti-reflective coating applied thereto. As shown, the chirped mirror 60 includes a substrate body 62 defining at least one surface 64. At least one processing layer 66 is applied to the surface 64 of the substrate body 62, although those skilled in the art will appreciate that the processing layers 66 may be applied to any surface of the substrate body 62. Like the previous embodiment, the processing layer 66 may be formed from any variety of materials, including, for example, SiO₂, amorphous carbon (a-C, a-C;H), SiC, polymeric-like carbon (PLC), hydrogenated diamond-like carbon, HfO₂, or similar materials using any variety of deposition techniques known in the art. In one embodiment, the processing layer 66 is formed from amorphous materials, although those skilled in the art will appreciate that the processing layer 66 need not be manufactured from amorphous materials.

Thereafter, the processing layer 66 may undergo one or more nano-texturing processes. For example, in one embodiment the processing layer 66 undergoes at least one plasma etch process thereby creating a nano-textured processing layer. Like the previous embodiment, the nano-texturing process may be applied to surface 70 of the processing layer 66. In an alternate embodiment, the nano-texturing process is applied to surface 68 of the processing layer 66. Optionally, the nano-texturing process may be applied to both surfaces 68, 70 of the processing layer 66. Further, the nano-texturing pattern formed on at least one of the surfaces 68, 70 of the processing layer 66 may comprise a random pattern, a non-random pattern, a uniform pattern, and or a non-uniform pattern.

As shown, a multi-layer dielectric stack 76 may be applied to the processing layer 66 of the substrate body 62. Like the previous embodiment, the multilayer dielectric stack 76 comprises alternating layers of materials having a high index of refraction and materials having a low index of refraction. For example, in the illustrated embodiment dielectric layers 78, 82 are formed from materials having a high index of refraction. In contrast, layers 80, 84 are comprised of materials having a low index of refraction. Exemplary materials used to form the layers of material having a high index of refraction 78, 82 include, without limitation, TiOₓ, Nb₂O₃, Ta₂O₅, HfO₂, Sc₂O₃, Y₂O₃, Al₂O₃, Gd₂O₃. Similarly, exemplary materials used to form the layers of material having a low index of refraction 80, 84 include, without limitation, SiO₂, MgF₂, Al₂O₃, and AlF₉. Optionally, the multilayer stack 76 may be manufactured with one or more layers of non-dielectric materials. Any number of layers of dielectric material may be applied to the multilayer stack 76 using any variety of deposition processes. In one embodiment, the multilayer stack 76 may or may not be nano-textured. Optionally, an additional processing layer may be applied to the multilayer dielectric stack 76 similar to the processing layer 66 described above (see FIG. 1). As such, the chirped mirror 60 may include two or more processing layers thereon. As a result, the nano-textured processing layer 66 and multilayer dielectric stack 76 of the chirped mirror 60 produces a chirped mirror 6 multilayer stack 66 having a broadband anti-reflective coating having a high damage threshold and configured to minimize ripples associated with group delay dispersion.

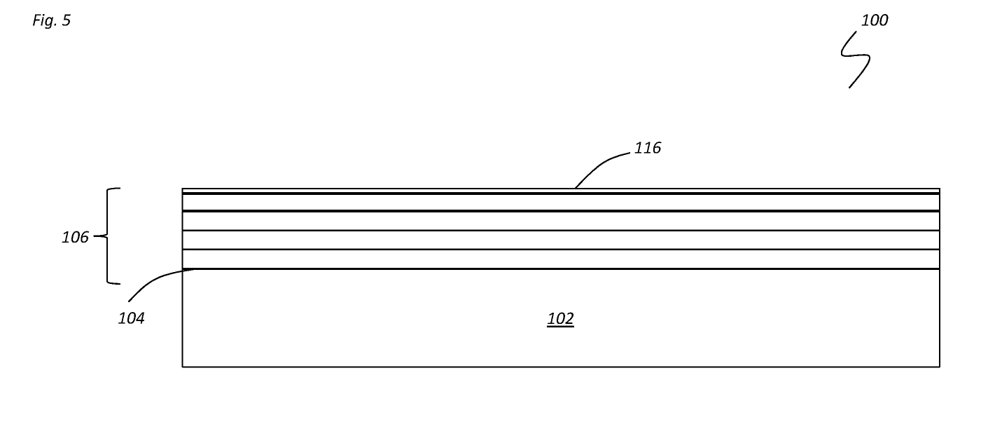

FIG. 5 shows another embodiment of a chirped mirror having a nano-textured anti-reflective coating applied thereto. Like the previous embodiments, the chirped mirror 100 includes a substrate body 102 defining at least one surface 104. Again, a multi-layer dielectric stack 106, similar to the multilayer dielectric stacks described above, may be applied to the surface 104 of the substrate body 102. However, unlike the previous embodiments, at least one supplemental substrate 116 having at least one nano-textured surface is provided. Any variety of methods including plasma etching or the like may be used as a nano-texturing process on the supplemental substrate 116. In one embodiment, the supplemental substrate 116 is manufactured from silica. In another embodiment the supplemental substrate 116 may be manufactured from SiC. Optionally, the supplemental substrate 116 may be manufactured from SiO₂, amorphous carbon (a-C, a-C;H), SiC, polymeric-like carbon (PLC), hydrogenated diamond-like carbon, HfO₂, or similar materials. In one embodiment, the supplemental substrate 116 is formed from amorphous materials, although those skilled in the art will appreciate that the supplemental substrate 116 need not be manufactured from amorphous materials. Those skilled in the art will appreciate that the supplemental substrate 116 may be manufactured from any variety of materials. Further, the supplemental substrate 116 may comprise a planar body, a wedge body, and the like and/or may include one or more surface features configured to reduce reflectance and/or dispersion thereon. Thereafter, supplemental substrate 116 is coupled to the multilayer dielectric stack 106 using bonding methods known in the art. As a result, the supplemental substrate 116 having at least one nano-textured surface and/or multilayer dielectric stack 106 of the chirped mirror 100 produces a chirped mirror 100 having a broadband anti-reflective coating having a high damage threshold and configured to minimize ripples associated with group delay dispersion.

The embodiments disclosed herein are illustrative of the principles of the invention. Other modifications may be employed which are within the scope of the invention. Accordingly, the devices disclosed in the present application are not limited to that precisely as shown and described herein.

What is claimed:

1. An optical component having a hybrid nano-textured anti-reflective coating, comprising:
at least one substrate having at least one substrate body defining at least one surface;
at least one layer applied to the at least one surface of the at least one substrate body; and
at least one nano-textured surface formed in the at least one layer applied to the at least one surface of the at least one substrate body.

2. The optical component having a hybrid nano-textured anti-reflective coating of claim 1 wherein the at least one substrate is manufactured from a nonlinear optical material.

3. The optical component having a hybrid nano-textured anti-reflective coating of claim 2 wherein the at least one substrate is manufactured from β-Barium borate.

4. The optical component having a hybrid nano-textured anti-reflective coating of claim 2 wherein the at least one substrate is manufactured from at least one material selected from the group consisting of lithium triborate, cesium lithium borate, bismuth borate, potassium titanyl phosphate, potassium dihydrogen phosphate and deuterated potassium dihydrogen phosphate.

5. The optical component having a hybrid nano-textured anti-reflective coating of claim 1 wherein the at least one substrate is manufactured from an anisotropic optical material.

6. The optical component having a hybrid nano-textured anti-reflective coating of claim 1 manufactured from at least one material selected from the group consisting of yttrium aluminum garnet, lutetium aluminum garnet, calcium fluoride,

7. The optical component having a hybrid nano-textured anti-reflective coating of claim 1 wherein the at least one layer applied to the at least one surface comprises a multilayer dielectric stack having alternating layers of materials having a high index of refraction and low index of refraction.

8. The optical component having a hybrid nano-textured anti-reflective coating of claim 7 wherein at least one of the layers of high index of refraction materials is selected from the group consisting of TiOₓ, TiO₂, Nb₂O₃, Ta₂O₅, HfO₂, Sc₂O₃, Y₂O₃, Al₂O₃, and Gd₂O₃.

9. The optical component having a hybrid nano-textured anti-reflective coating of claim 7 wherein at least one of the layers of low index of refraction materials is selected from the group consisting of SiO₂, Mg F₂, Al₂O₃, and AlF₃.

10. The optical component having a hybrid nano-textured anti-reflective coating of claim 7 wherein the at least one nano-textured surface is formed using a plasma etching process

11. The optical component having a hybrid nano-textured anti-reflective coating of claim 7 wherein the optical component comprises a chirped mirror.

12. An optical component having a hybrid nano-textured anti-reflective coating, comprising:
at least one substrate having at least one substrate body defining at least one surface;
at least one layer applied to the at least one surface of the at least one substrate body;
at least one nano-textured surface formed in the at least one layer applied to the at least one surface of the at least one substrate body; and
at least one processing layer applied to the at least one of the at least one substrate body and the at least one nano-textured surface.

13. The optical component having a hybrid nano-textured anti-reflective coating of claim 12 wherein the at least one layer applied to the at least one surface comprises a multilayer dielectric stack having alternating layers of materials having a high index of refraction and low index of refraction.

14. The optical component having a hybrid nano-textured anti-reflective coating of claim 13 wherein at least one of the layers of high index of refraction materials is selected from the group consisting of TiOₓ, TiO₂, Nb₂O₃, Ta₂O₅, HfO₂, Sc₂O₃, Y₂O₃, Al₂O₃, and Gd₂O₃.

15. The optical component having a hybrid nano-textured anti-reflective coating of claim 13 wherein at least one of the layers of low index of refraction materials is selected from the group consisting of SiO₂, Mg F₂, Al₂O₃, and AlF₃.

16. The optical component having a hybrid nano-textured anti-reflective coating of claim 12 wherein the at least one nano-textured surface is formed using a plasma etching process

17. The optical component having a hybrid nano-textured anti-reflective coating of claim 12 wherein the optical component comprises a chirped mirror.

18. The optical component having a hybrid nano-textured anti-reflective coating of claim 12 wherein the at least one processing layer is manufactured from SiO₂.

19. The optical component having a hybrid nano-textured anti-reflective coating of claim 12 wherein the at least one processing layer is manufactured from a material selected from the group consisting of amorphous carbon (a-C, a-C;H), SiC, polymeric-like carbon (PLC), hydrogenated diamond-like carbon, and HfO₂.

20. A method of manufacturing an optical component having a broadband anti-reflective coating having a high damage thresholds comprising:
providing a substrate having at least one substrate body;
applying at least one layer to the at least one surface of the at least one substrate body; and
forming at least one nano-textured surface on the at least one layer applied to the at least one surface of the at least one substrate body.

21. The method of claim 20 wherein the at least one layer is applied to the at least one substrate body using a vacuum deposition process.

22. The method of claim 20 where the at least one layer is applied to the at least one substrate body using a sol-gel deposition process

23. The method of claim 20 wherein the at least one nano-textured surface is formed using a plasma etching process.

24. The method of claim 20 further comprising applying at least one supplemental substrate to the at least one substrate body.
